(19) United States
(12) Patent Application Publication
(10) Pub. No.: US 2004/0189676 A1
(43) Pub. Date: Sep. 30, 2004

(54) Method, apparatus , and system for selectively combining video signals

(76) Inventor: Lee R. Dischert, Burlington, NJ (US)

Correspondence Address: RATNERPRESTIA, P O BOX 980, VALLEY FORGE, PA, 19482-0980, US

(21) Appl. No.: 10/395,664

(22) Filed: Mar. 24, 2003

(51) Int. Cl. G09G 5/00

(52) U.S. Cl. 345/639; 701/1; 345/611

(57) ABSTRACT

A method, apparatus, and system for combining a first signal and a second signal is disclosed, e.g., superimposing graphic signals on video signals. A first signal containing an object and an object indicator, e.g., a chroma key background color or a separate signal indicating presence or absence of an object, is used to determine weighting values for pixels at the edges of the object. The weighting values are then used to blend the first signal and a second signal at the edges of the object to minimize sharp transitions, thereby minimizing aliasing.

### FIELD OF THE INVENTION

The present invention relates to the field of video signal processing and, more particularly, to methods, apparatus, and systems for combining video signals.

### BACKGROUND OF THE INVENTION

Television systems process graphic signals and video signals separately. When combining the picture elements (“pixels”) of the graphic and video signals for display on a common display device such as a television monitor, the graphic signal is “keyed” onto the video signal using “real time” video switching. The graphic signal contains a graphic object and a chroma key background color (e.g., green) that extends to the edges of the graphic object. A switch passes either the video signal or the graphic signal responsive to the graphic signal. When the switch detects the chroma key background color in the graphic signal, the switch passes the video signal. Conversely, when the switch does not detect the chroma key background color, indicating the presence of the graphic object, the switch passes the graphic signal.

The graphic signal and the video signal are combined on a pixel-by-pixel basis to form a combined graphic/video signal. Since, the chroma key background color extends to the edge of the graphic object, “aliasing” may occur at the edges of the graphic object when combined with the video signal due to sharp transitions between the graphic object and the video signal. Aliasing results in the generation of aliasing artifacts such as “stair steps” when the combined graphic/video signal is displayed on a display device. Many viewers find programs containing these aliasing artifacts distracting, thus diminishing these viewers' enjoyment of the programs.

Accordingly, methods, apparatus, and systems are needed to minimize aliasing when combining graphic and video signals. The present invention addresses this need among others.

### SUMMARY

The present invention provides a method, apparatus, and system for superimposing one video signal onto another such as a graphic signal onto a video signal. A first signal has an object and an object indicator that indicates the presence of graphic object, or lack thereof, such as a chroma key background of a chroma key background color. The present invention satisfies the aforementioned need by determining a weight value for pixels of the first signal, weighting the corresponding pixels of the first and second signals responsive to the weight value, and combining the weighted first and second signals to form a combined signal for display on a display device such as a television monitor. The graphic signal and the video signal are weighted such that the graphic signal and the video signal are blended at the edges of the graphic object. Blending of the graphic signal and video signal at the edges of the graphic object when combining the graphic signal and the video signal minimizes sharp transitions between the graphic object and the video signal, thereby reducing aliasing.

A method, apparatus, and system in accordance with the present invention combines a first signal and a second signal corresponding to the first signal, the first signal including an object and a chroma key background.

The method includes processing the first signal to derive a weighting value for a reference pixel responsive to the relative presence of chroma key background color in a group of pixels including the reference pixel and an arrangement of other pixels corresponding to the reference pixel and combining the first signal and the second signal corresponding to the reference pixel responsive to the weighting value to form a combined signal.

The apparatus includes a processor that produces a weight value for a reference pixel of the first signal responsive to the relative presence of chroma key background color detected in a group of pixels including the reference pixel and an arrangement of other pixels corresponding to the reference pixel and a combiner that combines the first signal and the second signal responsive to the weight value to form a combined signal.

The system includes means for processing the first signal to derive a weighting value for a reference pixel responsive to the relative presence of the chroma key background color in a group of pixels including the reference pixel and an arrangement of other pixels corresponding to the reference pixel and means for combining the first signal and the second signal corresponding to the reference pixel responsive to the weighting value to form a combined signal.

### BRIEF DESCRIPTION OF THE DRAWINGS

The invention is best understood from the following detailed description when read in connection with the accompanying drawings, with like elements having the same reference numerals. This emphasizes that according to common practice, the various features of the drawings are not drawn to scale. On the contrary, the dimensions of the various features are arbitrarily expanded or reduced for clarity. Included in the drawings are the following features:

FIG. 1 is a block diagram of a combining apparatus in accordance with the present invention;

FIG. 2 is a block diagram partly in logic diagram form of a background detector for use in the combining apparatus of FIG. 1;

FIG. 3 is a block diagram of a weighting circuit for use in the combining apparatus of FIG. 1;

FIG. 4 is an illustrative representation of a graphic signal having a graphic object and a chroma key background of a chroma key background color;

FIG. 5 is an illustrative representation of weighting values that may be produced by the weighting circuit of FIG. 3;

FIG. 6 is an alternative embodiment of a look-up table suitable for use in the weighting circuit depicted in FIG. 3;

FIG. 7 is a circuit diagram of a mixer/multiplier suitable for use in the combining apparatus of FIG. 1; and

FIG. 8 is a circuit diagram of an alternative mixer/multiplier suitable for use in the combining apparatus of FIG. 1.

### DETAILED DESCRIPTION OF THE INVENTION

FIG. 1 depicts a television receiver 100 including a combining apparatus 102 that combines a graphic signal or color-keyed video signal and a non color-keyed video signal for display on a display device 104 such as a television monitor. Although the combining apparatus 102 of the present invention may be used in essentially any application where a first video or graphic signal is combined with a second video or graphic signal, it is especially useful for superimposing graphic signals onto video signals in a television receiver. Accordingly, the present invention is described in conjunction with such a use.

The combining apparatus 102 combines a graphic signal and a video signal to form a combined graphic/video signal. In the illustrated embodiment, the combining apparatus includes a background detector 106, a weighting circuit 108, and a mixer/multiplier 110. In an exemplary embodiment, the graphic signal is a conventional graphic signal that includes a graphic object and a chroma key background and the video signal is a conventional video signal such as a baseband NTSC television signal.

The background detector 106 processes the graphic signal to identify the presence of the chroma key background. In an exemplary embodiment, the background detector 106 identifies the presence of the chroma key background on a pixel by pixel basis and produces a one-bit indicator representing the presence of the chroma key background in each pixel. For example, the background detector may generate a low value, e.g., “0,” if the chroma key is detected and a high value, e.g., “1,” if the chroma key is not detected.

In certain exemplary embodiments, the background detector 106 also removes the chroma key background from the graphic signal. The exemplary background detector 106 removes the chroma key background by detecting the presence of the chroma key background color in the graphic signal on a pixel-by-pixel basis and setting the values of the individual pixels containing detected chroma key background color to a predefined value. In an exemplary embodiment, the predefined value is a value that has a non-display value, e.g., black. Combining a pixel of the graphic signal having a non-display value with a corresponding pixel from the video signal results in only the pixel of the video signal being viewable on a display device 104. In certain embodiments, the chroma key background color has a non-display value. Thus, in accordance with this embodiment, the background detector 106 does not remove the chroma key background from the graphic signal.

In certain exemplary embodiments, rather than detecting chroma key background, the background detector 106 processes the graphic signal on a pixel-by-pixel basis to detect the presence/lack of the graphic object or to detect a separate signal provided with the graphic signal that indicates graphic object or non-graphic object. In an exemplary embodiment, the background detector 106 identifies the presence of a graphic object on a pixel-by-pixel basis and produces a one-bit indicator representing the presence of the graphic object in each pixel. For example, the background detector 106 may produce a high value, e.g., “1” if a graphic object is detected and a low value, e.g., “0,” otherwise.

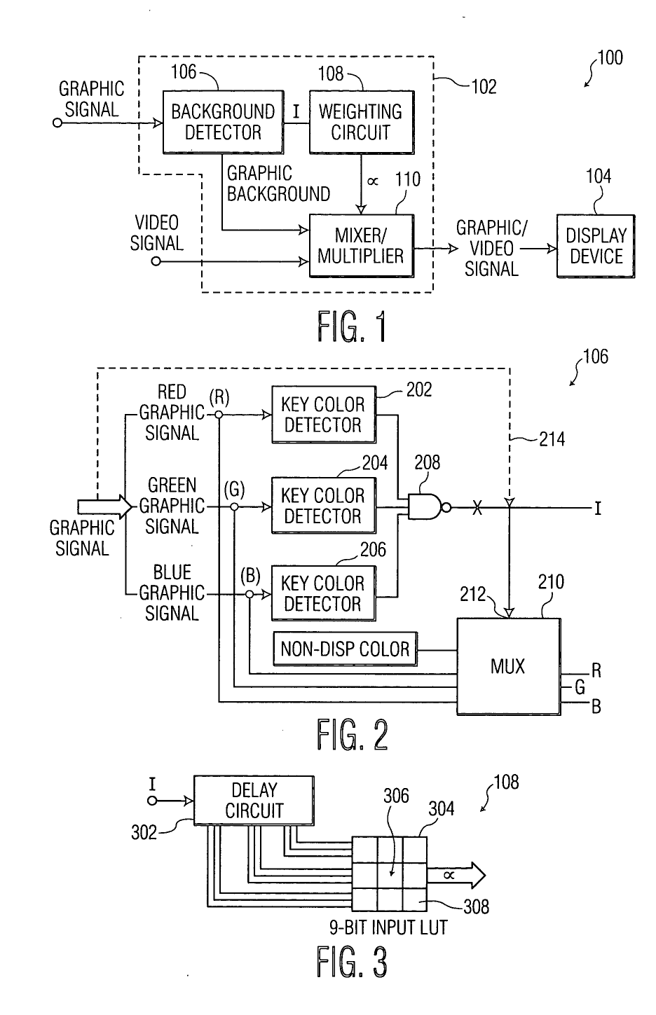

FIG. 2 depicts an exemplary background detector 106 for detecting the presence of the chroma key background color and removing the chroma key background on a pixel-by-pixel basis. In the embodiment illustrated in FIG. 2, the graphic signal is a conventional RGB signal that includes a red (R) component, a green (G) component, and a blue (B) component. Although a three component RGB signal is depicted, it will be readily apparent to those skilled in the art that the graphic signal may include other combinations of primary color signals or color difference signals such as a two component signal (e.g., a conventional R-Y, B-Y signal), other three component signals (e.g., a conventional Y, Cr, Cb signal), or essentially any signal for carrying color graphic or video signals.

The exemplary background detector 106 depicted in FIG. 2 includes a first key color detector 202, a second key color detector 204, a third key color detector 206, a logic gate 208, and a multiplexer 210. In the illustrated embodiment, the key color detectors 202-206 detect a chroma key background color in an RGB signal. The exemplary chroma key background color in a RGB signal has a red component, a green component, and a blue component. One or more of the color components have a display value that together make up the chroma key background color. For example, if the chroma key background color is green, the green chroma component has a display value and the red and blue chroma components have a non-display value. If the chroma key background color is bluish-green, the chroma key background has a blue component and a green component.

Each key color detector 202-206 detects the amplitude of a particular color component of the chroma key background color within a corresponding graphic signal. For example, the first key color detector 202 detects the amplitude of the red component of the chroma key background color in the R component of the graphic signal. When the chroma key background color is present, each of the key color detectors 202 detects the corresponding amplitude of its respective color component. For example, if the chroma key background color is green, the red and blue key color detectors 202, 206 each expect to receive non-display values and the green key color detector 204 expects to receive a green value having an amplitude that matches the value of the chroma background key color. If the red and blue key color detectors 202, 206 each receive non-display values and the green key color detector 204 receives the correct value for the green background key color, each key color detector produces an indicator indicating the presence of the chroma key background color component such as a high value (e.g., a logic state of “1”). Those of skill in the art will recognize that if only two color difference signals are in use, only two of the key color detectors are necessary. Furthermore, the background detector 106 may detect a range of amplitude values for each of the signals as corresponding amplitudes of the chroma key background color components. In addition, those of skill in the art will recognize that the key color detectors 202-206 are optional if the chroma key background color is a non-display color.

The logic circuit 208 combines the chroma key indicators from the key color detectors 202-206 to generate a signal, I, indicating the presence of the chroma key background color. In the illustrated embodiment, the logic circuit 208 is a NAND gate. If each of the key color detectors 202-206 produces a high value concurrently, indicating the presence of the chroma key background color, the NAND gate produces a low value, e.g., a logic state of “0.” Otherwise, if any of the key color detectors 202-206 produce a low value, the NAND gate produces a high value.

The optional multiplexer 210 removes the chroma key background from the graphic signal. The multiplexer 210 receives the signal, I, indicating the presence of the chroma key background color at a control port 212. The RGB signals are applied to one data input port of the multiplexer 210. In addition, a predefined value (e.g., a non-display value) is applied to the other data input port of the multiplexer 210. The multiplexer 210 is responsive to the presence of the chroma key background indicator at the control port 212. If the chroma key background indicator indicates the presence of the chroma key background, the multiplexer 210 passes the non-display value as the RGB graphic signal. Conversely, if the chroma key background indicator indicates that the chroma key background is not present, the multiplexer 210 passes the RGB signals unaltered. In exemplary embodiments of the invention, the non-display value may be black, the graphic color or a saved pixel value representing a last pixel that was not the chroma key background color.

In certain exemplary embodiments, where the graphic object itself or a separate signal associated with the graphic signal indicates the presence of the graphic object, the background detector 106 does not detect the presence of chroma key background color. In accordance with such embodiments, a signal such as a graphic object signal 214 is separated or generated from the graphic signal in a manner that will be apparent to those of skill in the art of television signal processing. Since chroma key background color is not detected, key color detectors, 202, 204, and 206 are unnecessary and, therefore, can be eliminated.

In certain exemplary embodiments, the graphic object indicator signal 214 controls the optional multiplexer 210 such that when a pixel containing a graphic object is present, the multiplexer passes the graphic signal and passes a non-display color otherwise. In certain other exemplary embodiments, a non-display color is present in the graphic signal when the graphic object is not present, thus eliminating the need for the multiplexer 210.

Referring back to FIG. 1, the weighting circuit 108 generates a weight value, α, for a reference pixel based on the reference pixel and an arrangement of other pixels proximate the reference pixel. The weight value, α, is based on the relative presence of the chroma background (or, alternatively, the presence/lack of the graphic object) in a group of pixels including the reference pixel and the arrangement of other pixels. In an exemplary embodiment, described in detail below, the weighting circuit 108 detects edges and diagonals of graphic objects within the graphic signal and produces a weight value, α, appropriate for the detected edge.

FIG. 3 depicts an exemplary weighting circuit 108. The weighting circuit 108 illustrated in FIG. 3 includes a delay circuit 302 and a look-up table 304. The delay circuit 302 introduces delay to the graphic signal such that multiple adjacent pixels from successive video lines are provided concurrently. In an exemplary embodiment, the delay circuit 302 introduces delay to allow concurrent processing of a reference pixel 306 and an arrangement of other pixels corresponding to the reference pixel 306 (represented by other pixel 308).

In the exemplary embodiment, the arrangement of other pixels corresponding to the reference pixel 306 include 8 pixels adjacent to the reference pixel 306, i.e., pixels above and below the reference pixel, pixels to the left and right of the reference pixels, and pixels diagonal to the reference pixel. As described in detail below, the look-up table 304 provides a plurality of different weighting values based on different combinations of chroma key background indicators present in a group of pixels including the reference pixel and the arrangement of other pixels.

In an exemplary embodiment, the delay 302 delays the reference pixel 306 one pixel period with respect to the pixel to the left of the reference pixel 306 so that these two pixels are available concurrently. Likewise, the pixel to the right of the reference pixel is delayed one pixel period with respect to the reference pixel 306 so that these two pixels are available concurrently. Assuming an NTSC television system having a horizontal line scan time of 63.556 microseconds (1 H), the reference pixel is delayed 1 H with respect to the pixel below the reference pixel and the pixel above the reference pixel 306 is delayed 1 H with respect to the reference pixel so that these three pixels are available concurrently. The delays used to make the remaining pixels available concurrently with the reference pixel 306 will be readily apparent to those of skill in the art of television signal processing.

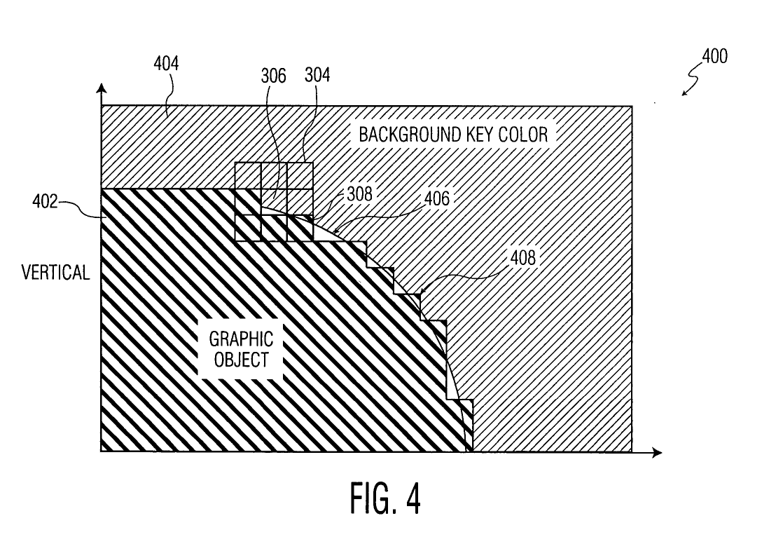

FIG. 4 is a graphical depiction of a portion 400 of a graphic signal and the pixels presented to the look-up table 304 of FIG. 3. The graphical depiction includes a graphic object 402 and a chroma key background 404 of a chroma key background color. Also included is an actual edge line 406 that represent the actual edge of the graphic object 402 and an aliased edge line 408 that represents the “pixelation” of the graphic object 402. Conceptually, during processing, the look-up table 304 is applied to the graphic signal and generates a weighting value for each pixel within the graphic object 402 and the chroma key background 404. The weighting value that the look-up table produces is for the reference pixel 306 and is responsive to the relative presence of chroma key background color in a group of pixels including the reference pixel 306 and the arrangement of pixels corresponding to the reference pixel. In an exemplary embodiment, the look-up table 304 produces a weight value, α, responsive to a pattern of pixels within the look-up table 304 having the chroma key background color. In accordance with this embodiment, the look-up table 304 detects edges of graphic objects within the graphic signal. In an alternative exemplary embodiment, the look-up table produces a weight value, α, responsive to the number of pixels having the chroma key background color.

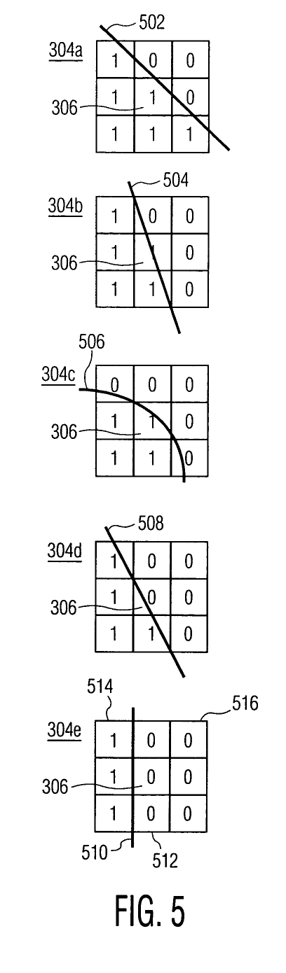

FIG. 5 depicts various exemplary weight values produced by the look-up table 304 of FIGS. 3 and 4 when detecting edges of graphic objects within a graphic signal. Look-up tables 304a-e illustrate detected edges of graphic objects within the graphic signal. In the look-up tables 304a-e of FIG. 5, a one (“1”) represents the presence of the graphic object 402 (FIG. 4) and a zero (“0”) represents the presence of the chroma key background color of the chroma key background 404 (FIG. 4). In an exemplary embodiment, when the reference pixel should be all graphic signal, the look-up table 304 produces a weight value, α, of one (“1”). When the reference pixel should be all video signal, the look-up table 304 produces an a of zero (“0”). When the reference pixel should be a blend of the graphic signal and the video signal, e.g., at the edges of the graphic object within the graphic signal, the look-up table 304 produces an α having a value between zero and one having a quantized linear relationship corresponding to the percentage of the reference pixel that is grouped with the graphic object by an edge 406 (FIG. 4) of the graphic object passing through the reference pixel.

In the exemplary embodiment, look-up table 304a produces a weight value, α, of 0.75 for the illustrated pattern of chroma key background color present in the look-up table 304a. Assuming an edge 502, e.g., of the graphic object 402, passes through the pattern illustrated in look-up table 304a as shown, approximately 75% of the reference pixel 306 is grouped with the graphic object 402. In an exemplary embodiment, when an assumed edge groups more than 50% of the reference pixel 306 with the graphic object, the graphic signal for the reference pixel 306 is weighted more heavily than the video signal for the reference pixel 306. In the illustrated embodiment, the percentage of the reference pixel 306 grouped with the graphic object by the assumed edge 502, i.e., 75%, corresponds to the weight value, α, of 0.75.

Look-up table 304b produces a weight value, α, of 0.5 for the illustrated pattern of chroma key background color present in the look-up table 304b. Assuming an edge 504, e.g., of the graphic object 402, passes through the pattern illustrated in look-up table 304b as shown, approximately 50% of the reference pixel 306 is grouped with the graphic object 402. In an exemplary embodiment, when an assumed edge groups approximately 50% of the reference pixel 306 with the graphic object, the graphic signal and the video signal for the reference pixel 306 are weighted substantially the same. In the illustrated embodiment, the percentage of the reference pixel 306 grouped with the graphic object by the assumed edge 502, i.e., 50%, corresponds to the weight value, α, of 0.5.

Look-up table 304c produces a weight value, α, of 0.5 for the illustrated pattern of chroma key background color present in the look-up table 304c. Assuming an edge 506, e.g., of the graphic object 402, passes through the pattern illustrated in look-up table 304c as shown, approximately 50% of the reference pixel 306 is grouped with the graphic object 402. In an exemplary embodiment, as with look-up table 304b described above, when an assumed edge groups approximately 50% of the reference pixel 306 with the graphic object, the graphic signal and the video signal for the reference pixel 306 are weighted substantially the same. Accordingly, the weight value, α, for the pattern illustrated in look-up table 304c is also 0.5.

Look-up table 304d produces a weight value, α, of 0.25 for the illustrated pattern of chroma key background color present in the look-up table 304d. Assuming an edge 502, e.g., of the graphic object 402, passes through the pattern illustrated in look-up table 304d as shown, approximately 25% of the reference pixel 306 is grouped with the graphic object 402. In an exemplary embodiment, when an assumed edge groups less than 50% of the reference pixel 306 with the graphic object, the video signal for the reference pixel 306 is weighted more heavily than the graphic signal for the reference pixel 306. In the illustrated embodiment, the percentage of the reference pixel 306 grouped with the graphic object by the assumed edge 508, i.e., 25%, corresponds to the weight value, α, of 0.25.

Look-up table 304e produces a weight value, α, of 0.0 for the illustrated pattern of chroma key background color present in the look-up table 304e. Assuming an edge 510, e.g., of the graphic object 402, passes through the pattern illustrated in look-up table 304e as shown, 0% of the reference pixel 306 is grouped with the graphic object 402. In an exemplary embodiment, when an assumed edge groups approximately 0% of the reference pixel 306 with the graphic object, the video signal for the reference pixel 306 is weighted much more heavily than the graphic signal for the reference pixel 306 such that the resultant reference pixel is all or substantially all video signal. In the illustrated embodiment, the percentage of the reference pixel 306 grouped with the assumed edge 510, i.e., 0%, corresponds to the weight value, α, of 0.0.

If all zeros (“0”) in the center column 512 of look-up table 304e are ones (“1”) such that each pixel in a left column 514 and the center column 512 contains a one (“1”), an assumed edge (not shown) would pass between the center column 512 and a right column 516 such that approximately 100% of the reference pixel 306 is grouped with the graphic object 402. In an exemplary embodiment, when an assumed edge groups approximately 100% of the reference pixel 306 with the graphic object, the graphic signal for the reference pixel 306 is weighted much more heavily than the video signal for the reference pixel 306 such that the resultant reference pixel is all or substantially all graphic signal. In the illustrated embodiment, the percentage of the reference pixel 306 grouped with the assumed edge 510, i.e., 100%, corresponds to the weight value, α, of 1.0.

The illustrated look-up table 304 has 512 different combinations of graphic object indicators and chroma key background indicators that form patterns within the look-up table 304. In an exemplary embodiment, the remaining 506 combinations (512 minus the 6 patterns described above with reference to FIG. 5) may be derived by one of skill in the related arts using the examples illustrated in FIG. 5, with each combination producing an assigned weight value, α, of 0, 0.25, 0.5, 0.75, or 1. For example, one of skill in the art can view a look-up table 304 containing graphic object indicators and chroma key background color indicators and draw a line through the look-up table 304 that represents an assumed edge. The one of skill in the art then determines the percentage of the reference pixel that represents the graphic object defined by the assumed edge and assigns the closest corresponding weight value. It is recognized that certain patterns such as a “checkerboard” pattern lack an easily definable edge. In an exemplary embodiment, such patterns receive a weight value, α, of 1 if the reference pixel contains a graphic object indicator and a weight value, α, of 0 if the reference pixel contains a chroma key background color indicator. Those of skill in the art will recognize that the assigned weight values may include essentially any number of weight values, e.g., 0, 0.5, and 1.

FIG. 6 depicts an alternative look-up table 600 for processing a reference pixel 602 and an alternative arrangement of other pixels corresponding to the reference pixel 602 (represented by other pixel 604). In the illustrated embodiment, the arrangement of other pixels include at least two pixels to the left of the reference pixel 602, at least two pixels to the right of the reference pixels 602, and pixels above and below the reference pixel 602. If the look-up table 600 uses two pixels to the left and the right of the reference pixel 602 and pixels above and below the reference pixel 602 (depicted by the solid lines of the alternative look-up table 600), edge detection is performed with one less pixel than the look-up table 304 of FIG. 3. Thus, one less tap of delay circuit 302 (FIG. 3) is needed, thereby reducing system costs. If the look-up table 600 uses three pixels to the left and right of the reference pixel 602 and two pixels above and below the reference pixel 602 (depicted by the solid lines and the broken lines of the alternative look-up table 600), edge detection is performed over greater spatial distances than the look-up table 304 of FIG. 3. Therefore, the look-up table 600 in accordance with this embodiment offers further refinement of the weight values for the reference pixel 602 than the look-up table 304 for the reference pixel 306 of FIG. 3. Variations of these alternative embodiments will be readily apparent to those of skill in the art. In addition, other look-up tables having alternative arrangements of other pixels may be used, e.g., a circular or rectangular pixel arrangements. The modification of the delay 302 (FIG. 3) for use with the alternative look-up table arrangements will be readily apparent to those of skill in the art.

Referring back to FIG. 1, the mixer/multiplier 110 combines the graphic signal and the video signal responsive to the weight value, α, produced by the weighting circuit 108 to produce a combined graphic/video signal. The illustrated mixer/multiplier 110 receives a video signal, the graphic signal from the background detector 106, and the weighting value, α, from the weighting circuit 108. In an exemplary embodiment, the background detector 106 removes the chroma key background from the graphic signal. In an alternative exemplary embodiment, the chroma key background is not removed. In accordance with this alternative embodiment, the graphic signal is applied directly to the mixer/multiplier 110 or passes through the background detector 106 essentially unaltered.

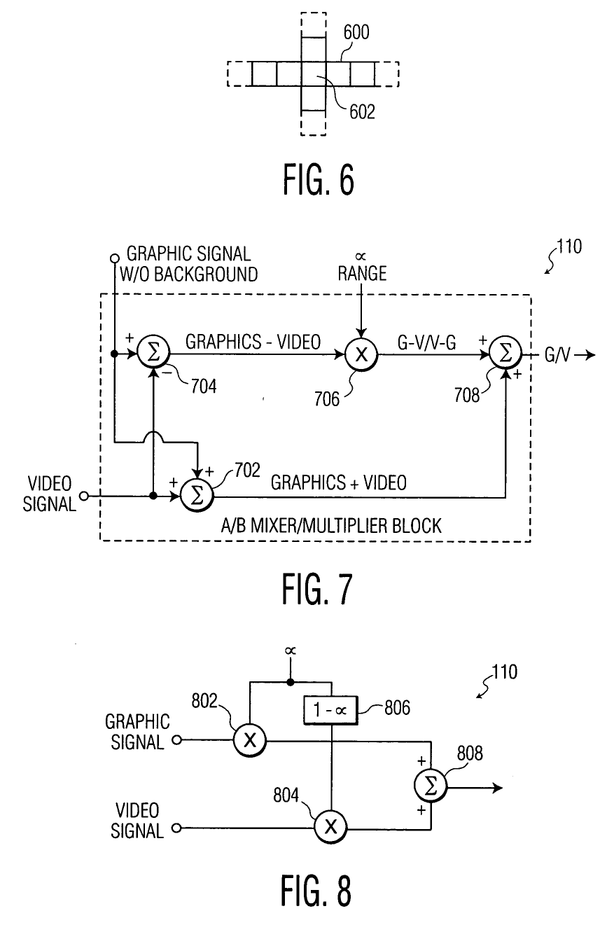

FIG. 7 depicts an exemplary mixer/multiplier 110. The exemplary mixer/multiplier 110 illustrated in FIG. 7 includes a first summation circuit 702, a second summation circuit 704, a multiplier 706, and a third summation circuit 708. The first summation circuit 702 adds the graphic signal and the video signal together to produce a first intermediate signal. The second summation circuit 704 subtracts the video signal from the graphic signal to produce a second intermediate signal.

The multiplier 706 weights the second intermediate signal. In an exemplary embodiment, the multiplier 706 multiplies the second intermediate signal by a value between “−1” and “1” for weight values, a, of zero to one, with a quantized linear relationship existing for intermediate values. Specifically, in an exemplary embodiment, if the weight value, (x, is zero, the multiplier 706 multiplies the second intermediate signal by “−1,” if the weight value, α, is one-half, the multiplier 706 multiplies the second intermediate signal by “0,” and if the weight value, α, is one, the multiplier 706 multiplies the second intermediate signal by “1.” In addition, in certain exemplary embodiments, if the weight value, α, is one-quarter, the multiplier 706 multiplies the second intermediate signal by “−0.5” and if the weight value, α, is three-quarters, the multiplier 706 multiplies the second intermediate signal by “0.5.” The third summation circuit 708 combines the first intermediate signal and the weighted second intermediate signal to form the combined graphic/video signal.

In accordance with the exemplary embodiment, a weight value, α, of 0, indicating all video signal weighting for the reference pixel, prompts the multiplier 706 to multiply the second intermediate signal by “−1,” which the summation circuit 708 combines with the first intermediate signal to produce an all video signal. A weight value, α, of 1, indicating all graphic signal weighting for the reference pixel, prompts the multiplier 706 to multiply the second intermediate signal by “1,” which, the summation circuit 708 combines with the first intermediate signal to produce an all graphic signal. A weight value, α, of one-half, indicating an equal mix of graphic signal and video signal for the reference pixel, prompts the multiplier 706 to multiply the second intermediate signal by “0.” This effectively eliminates the second intermediate signal, leaving the first intermediate signal containing both a graphic signal and a video signal to form the combined graphic/video signal. A weight value, α, of one-quarter or three-quarters, indicating a mix of graphic signal and video signal for the reference pixel, prompts the multiplier 706 to multiply the second intermediate signal by “−½” or “½,” respectively. Those of skill in the related arts will recognize that the exemplary embodiment of the mixer/multiplier 110 depicted in FIG. 7 effectively multiplies the graphic signal by the weight value, α, and the video signal by a complement of the weight value, i.e., 1−α, using one multiplier 706.

FIG. 8 depicts an alternative exemplary mixer/multiplier 110. The exemplary mixer/multiplier 110 illustrated in FIG. 8 includes a first multiplier 802, a second multiplier 804, a complement circuit 806, and a summation circuit 808. The first multiplier 802 multiplies the graphic signal by the weight value, α. The second multiplier 804 multiplies the video signal by a complement of the weight value, 1−α, produced by the complement circuit 806. The summation circuit 808 combines the weighted graphic signal and the weighted video signal to form the combined graphic/video signal.

Referring back to FIG. 1, the combined graphic/video signal produced by the mixer/multiplier 110 is displayed by the display device 104. In an exemplary embodiment, the display device is a conventional video display device such as a television monitor or projection television system.

An exemplary use of the present invention is now described with reference to FIGS. 1, 2, 3, 4, 5, 7, and 8. The combining apparatus 100 (FIG. 1) receives a graphic signal and a video signal. The background detector 106 detects the presence of chroma key background color in the graphic signal on a pixel-by-pixel basis to produce a chroma key background indicator, I, using key color detectors 202-206 and a combiner 208 (FIG. 2). In addition, the background detector 106 may remove the chroma key background from the graphic signal using the multiplexer 210 (FIG. 2), which is responsive to the indicator I. The weighting circuit 108 (FIG. 1) develops a weight value, α, based on a reference pixel and an arrangement of other pixels corresponding to the reference pixel using a delay 302 and a look-up table 304 (FIG. 3). The look-up table 304 processes the reference pixel and the arrangement of other pixels to develop a weight value, α, for weighing the reference pixel responsive to a pattern of chroma key background color indicators formed in the look-up table 304, such as illustrated in the exemplary look-up tables 304a-e (FIG. 5). The mixer/multiplier 110 (FIG. 1) combines the graphic signal and the video signal responsive to the weight value, α, using techniques such as shown in FIGS. 7 and 8. The mixer/multiplier 110 effectively multiplies the graphic signal by the weight value, cc, and the video signal by the complement of the weight value, 1−α. Multiplying the graphic signal by the weight value, α, and the video signal by the complement of the weight value, 1−α, removes sharp transitions between the graphic object and the video signal, thereby reducing aliasing that occurs during such transitions.

If the weighting circuit 108 (FIG. 1) determines that the reference pixel should be all graphic signal, the weighting circuit 108 generates a weight value, α, that the mixer/multiplier 110 uses to produce a combined graphic/video signal that reflect only the graphic signal.

If the weighting circuit 108 determines that the reference pixel should be all video signal, the weighting circuit 108 generates a weight value, α, that the mixer/multiplier 110 uses to produce a combined graphic/video signal that reflects only the video signal.

If the weighting circuit 108 determines that the reference pixel should be a mixture of both the graphic and video signals, the weighting circuit 108 generates a weight value, α, that the mixer/multiplier 110 uses to produce a combined graphic/video signal proportional to the weight value, α, that is a blend of the graphic signal and the video signal.

While a particular embodiment of the present invention has been shown and described in detail, adaptations and modifications will be apparent to one skilled in the art. Such adaptations and modifications of the invention may be made without departing from the scope thereof, as set forth in the following claims.

We claim:

1. A method for combining a first signal and a second signal corresponding to the first signal, the first signal including an object and a object indicator indicating the presence of the object, the method comprising the steps of:
processing the first signal to derive a weighting value for a reference picture element (pixel), responsive to the object indicator in a group of pixels including the reference pixel and a predefined arrangement of other pixels corresponding to the reference pixel; and
combining the first signal and the second signal corresponding to the reference pixel responsive to the weighting value to form a combined signal.

2. The method of claim 1, wherein the processing step comprises at least the steps of:
detecting a pattern of pixels having a chroma key background color from the reference pixel and the arrangement of other pixels; and
deriving the weight value responsive to the detected pattern.

3. The method of claim 1, wherein the arrangement of other pixels are eight pixels adjacent the reference pixel.

4. The method of claim 1, wherein the arrangement of other pixels include at least a first pixel above the reference pixel, a first pixel below the reference pixel, a first pair of horizontal pixels to the left of the reference pixel, and a second pair of horizontal pixels to the right of the reference pixel.

5. The method of claim 1, wherein the combining step comprises at least the steps of:
weighting the first signal by the weight value;
weighting the second signal by a complement of the weight value; and
combining the weighted first signal and weighted second signal.

6. The method of claim 1, wherein the object indicator is a chroma key background of a chroma key background color indicating lack of the object.

7. The method of claim 6, wherein the processing step to remove the chroma key background comprises at least the steps of:
detecting pixels within the first signal having the chroma key background color; and
setting the pixels having the chroma key background color to a predetermined value.

8. The method of claim 6, further comprising the step of:
processing the first signal to remove the chroma key background from the first signal prior to the combining step.

9. The method of claim 8, wherein the combining step comprises at least the steps of:
adding the second signal and the first signal with the chroma key background removed to form a first intermediate signal;
subtracting the second signal from the first signal with the chroma key background removed to form a second intermediate signal;
weighting the second intermediate signal responsive to the weight value; and
combining the first intermediate signal and the weighted second intermediate signal to form the combined signal.

10. A method for combining a graphic signal and a composite video signal corresponding to the graphic signal, the graphic signal including a graphic object and a chroma key background of a chroma key background color, the method comprising the steps of:
receiving the graphic signal and the composite video signal;
processing the received graphic signal to derive a weighting value for a reference pixel responsive to a pattern of pixels having the chroma key background from the reference pixel and an arrangement of other pixels corresponding to the reference pixel;
combining the graphic signal and the composite video signal corresponding to the reference pixel responsive to the weighting value to form a combined graphic/video signal; and
displaying the combined graphic/video signal on a display device.

11. The method of claim 10, wherein the combining step comprises at least the steps of:
weighting the graphic signal by the weight value;
weighting the composite video signal by a complement of the weight value; and
combining the weighted graphic signal and the weighted composite video signal to form the combined graphic/video signal.

12. The method of claim 10, wherein the processing step further comprises at least the steps of:
detecting pixels within the graphic signal having the chroma key background color; and
setting the pixels having the chroma key background color to a predefined color.

13. The method of claim 12, wherein the combining step comprises at least the steps of:
adding the processed graphic signal and the composite video signal to form a first signal;
subtracting the composite video signal from the processed graphic signal to form a second signal;
weighting the second signal responsive to the weight value; and
combining the first signal and the weighted second signal to form the combined graphic/video signal.

14. An apparatus that combines a first signal and a second signal corresponding to the first signal, the first signal including an object and a object indicator indicating the presence of the object, the apparatus comprising:
a processor that produces a weight value for a reference pixel of the first signal, responsive to the object indicator, in a group of pixels including the reference pixel and an arrangement of pixels corresponding to the reference pixel; and
a combiner that combines the first signal and the second signal responsive to the weight value to form a combined signal.

15. The apparatus of claim 14, wherein the processor is a look-up table.

16. The apparatus of claim 14, wherein the object indicator is a chroma key background of a chroma key background color indicating lack of the object.

17. The apparatus of claim 16, wherein the first signal includes at least two graphic signals, wherein the chroma key background color includes at least two color components corresponding to the at least two graphic signals, and wherein the background detector comprises at least:
at least two key color detectors corresponding to the at least two graphic signals, each of the at least two color detectors detecting the color component of the corresponding graphic signal to produce an indicator indicating the presence of the color component in the graphic signal;
a logic gate that detects the indicators of the at least two color key detectors and produces a chroma key indicator indicating the presence of the chroma key background color if all of the indicators indicate the presence of the color component in the respective graphic signal; and
a multiplexer responsive to the chroma key indicator receiving the at least two graphic signals and passing a predefined color value for each of the at least two graphic signals if the chroma key indicator indicated the presence of the chroma key background and passing the at least two graphic signals unaltered otherwise.

18. The apparatus of claim 16, wherein the chroma key background is removed from the first signal and wherein the combiner comprises at least:
a first summation circuit that adds the second signal and the first signal with the chroma key background removed to form a first intermediate signal,
a second summation circuit that subtracts the second signal from the first signal with the chroma key background removed to form a second intermediate signal;
a weighting circuit that weights the second intermediate signal responsive to the weight value; and
a third summation circuit that adds the first intermediate signal and the weighted second intermediate signal to form the combined signal.

19. A television signal processor that combines a graphic signal and a video signal corresponding to the graphic signal, the graphic signal including a graphic object and a chroma key background of a chroma key background color, the receiver comprising:
a weighting circuit that produces a weight value for a reference pixel responsive to a pattern of detected chroma key background color in the reference pixel and an arrangement of adjacent pixels corresponding to the reference pixel; and
a combiner that combines the graphic signal and the video signal responsive to the weight value to form a combined graphic/video signal.

20. A system for combining a first signal and a second signal corresponding to the first signal, the first signal including an object and a chroma key background of a chroma key background color, the system comprising:
means for processing the first signal to derive a weighting value for a reference pixel responsive to the relative presence of the chroma key background color in a group of pixels including the reference pixel and an arrangement of other pixels corresponding to the reference pixel; and
means for combining the first signal and the second signal corresponding to the reference pixel responsive to the weighting value to form a combined signal.
